(19) United States
(12) Patent Application Publication
(10) Pub. No.: US 2005/0112360 A1
(43) Pub. Date: May 26, 2005

(54) Process for tagging of manufactured articles with up-and down-converting metal oxide nanophosphors and articles produced thereby

(76) Inventors: Gerald Berger, Ann Arbor, MI (US); Richard M. Laine, Ann Arbor, MI (US); Jose Azurdia, Guatemala City (GT)

Correspondence Address: BROOKS KUSHMAN P.C., 1000 TOWN CENTER, TWENTY-SECOND FLOOR, SOUTHFIELD, MI, 48075, US

(21) Appl. No.: 10/723,709

(22) Filed: Nov. 26, 2003

(51) Int. Cl. B32B 5/16

(52) U.S. Cl. 428/323; 428/328; 428/690; 428/913; 283/92; 427/157; 427/180

(57) ABSTRACT

Manufactured articles are rendered identifiable as to their source or genuineness by incorporating one or more populations of up- and/or down-converting metal oxide or mixed metal oxides during or post manufacture. The nanoparticles exhibit emission of light upon irradiation by energy sources which allows comparison between the emission spectrum of an article with the emission expected of a genuine article or a material from a given manufacturing process, i.e. a batch of material.

### BACKGROUND OF THE INVENTION

1. Field of the Invention

The present invention is directed to the tagging of manufactured articles by incorporating within them up- and/or down-converting nanosphors which allow for identification of the source or genuineness of the articles.

2. Background Art

It is frequently desirable to identify the source of articles, or to be able to distinguish real articles from their counterfeit counterparts. For example, many countries have instituted anti-counterfeiting means for their paper currency, including color shifting inks, visible and invisible watermarks, holograms, and the like. As the ability of counterfeiters to cope with such security measures has increased, the complexity of the security measures has increased as well.

In the field of medical prostheses, it is possible to eradicate the manufacturer's markings or to alter them. Moreover, it is possible to substantially duplicate such devices by other manufacturers. It would be desirable to be able to verify the manufacturer of prostheses, and to be able to detect counterfeit devices.

In the field of explosives, it would be desirable to be able to determine the source of explosives materials, particularly at crime scenes or those resulting from terrorist activities such as car bombings or suicide bombings.

In the case of parts of metal, thermoset or thermoplastic polymers, ceramic materials, glass, and the like, it would be desirable, again, to be able to determine the manufacturer of the part or of components employed to manufacture the part.

Incorporating taggants into the aforementioned materials or components thereof has been practiced. For example, micron size glass beads of varying colors are available from Mo-Sci Corporation, Rolla, Mo. However, these beads are only suitable for certain applications. For example, they cannot be used when processing and/or use temperatures exceed 800° C. Due to their relatively large size, they can also easily alter the physical properties of the articles or compositions they are contained in, e.g. low melting metals such as aluminum. Moreover, and again because of their relatively large size, the particles are abrasive, and generally do not allow for the production of parts with highly polished surfaces.

Small, multicolored thermoset melamine polymer chips, such as those sold under the tradename “Microtaggants” from Microtrace, Inc., have also been used as taggants. Again, the particle sizes are large, e.g. 75-150 μm, and in this case, cannot survive processing or use at temperatures greater than about 200° C., which severely limits their use.

Attempts to use both of the above taggants in explosives has been investigated by the ATF (Bureau of Alcohol, Tobacco, and Firearms). Following an ammonium nitrate/fuel oil explosion, it was only possible to recover one Microsphere™ and no Microtaggants™. The extreme conditions encountered in explosive detonation are capable of destroying conventional taggants. More robust taggants are required.

During the melt processing and thermal forming of metals, conditions are also not compatible with conventional taggants. Aluminum casting, for example, is conducted at 660° C. or higher, with the corresponding temperature for iron and steel being greater than 1000° C. Ceramics processing frequently involves temperatures exceeding 1200-1500° C. Conventional taggants cannot survive these temperatures.

It would thus be desirable to provide taggants which, due to their small size, can be uniformly distributed within the articles they are contained in, i.e. are “pervasive,” without significantly altering the physical characteristics of the articles, and without being abrasive. It would be further desirable to provide taggants which are robust, and which can withstand elevated temperature processing and use. It would be further desirable to provide taggants which offer greater ability to be distinguished from other taggants, while offering numerous combinations of properties such that a large number of different taggants are possible.

### SUMMARY OF THE INVENTION

It has now been surprisingly discovered that up- and down-converting metal oxide particles in the nanosize range are robust enough to survive numerous and varied conditions of processing and use, and may be incorporated even in molten metals. In some instances, the taggants can be analyzed in the field to enable the source or genuineness of articles to be determined.

### BRIEF DESCRIPTION OF THE DRAWINGS

FIG. 1 is an x-ray diffraction spectrum of aluminum.

FIG. 2 are x-ray diffraction spectra of aluminum also containing nanoparticles doped with Er, with Tm, and with both Er and Tm.

FIG. 3 illustrates emission of the nanoparticle containing aluminums of FIG. 2 at 475 and 665 nm upon irradiation with a 980 nm infrared laser.

### DETAILED DESCRIPTION OF THE PREFERRED EMBODIMENT(S)

The taggants of the present invention are doped metal oxide or mixed metal oxide particles smaller in size than 0.5 μm, preferably 1-100 nm. The metal oxides or mixed metal oxides contain up- or down-converting luminescent centers which emit light in response to illumination by light of a different color, or by other energetic sources such as electron beams. Because the emitted light is of a different wavelength (or wavelengths) than the exciting light, a significant degree of radiant isolation with respect to the exciting light is obtained, and thus the taggant signals are easily distinguished from the exciting wavelength and background illumination.

The up- or down-converting luminescent centers are the result of doping the metal oxide particles with metals, particularly with transition or rare earth metals, and by suitable selection of dopant and dopant concentration, numerous varieties of nanoparticle taggants may be manufactured. With mixed metal oxides in particular, two or more modes of excitation may be provided, and thus in such cases, a single particle may be used as a taggant, as opposed, for example, to a mixture of different colored glass microspheres. Due to the ability to produce particles in the low nanosize range, i.e. 1-100 nm, the particles are not abrasive, but can actually assist in polishing surfaces when polishing is desirable.

The taggants of the subject invention may be produced by any suitable process which can provide doped, up- or down-converting metal oxide or mixed metal oxide particles of suitable size. Doped, mixed metal oxide particles are preferred for use at the taggants of the invention. The nanoparticles may consist, as previously indicated, of a doped single metal oxide, a doped homogenous mixed metal oxide, or a doped heterogenous (multi-phase) mixed metal oxide. The metal oxide particles may also consist of a single metal oxide, but with dopants heterogenously distributed within the particle. The morphology of the particles is thus not critical, so long as up-converting or down-converting luminescent centers are contained within the particles. Thus, particles with two phases distributed in a somewhat random manner are suitable, and preferred, as are also particles with core/shell morphology, where the core and shell have different metal oxide or mixed metal oxide compositions, different dopant compositions, or a combination of these attributes.

Methods of preparation of the up- and down-converting luminescent-center-containing nanoparticles are known. In general, such particles are synthesized by flame spray pyrolysis methods, preferably liquid feed flame spray pyrolysis, of metal oxide precursors which also contain dopant atoms, or of metal oxide precursors with dopant metal precursors, fed either separately but concurrently or as an admixture to the pyrolysis chamber.

Gas-feed flame spray pyrolysis (“FSP”) is a primary industrial method for the preparation of single metal oxide nanoparticles such as SiO₂ from SiCl₄ and RₓSiCl_{y} where R is a low molecular weight organic group, preferably a C₁₋₃ alkyl group, x is preferably 1 or 2, and the sum of x and y is 4, and TiO₂ from TiCl₄. FSP of mixtures of SiCl₄ and TiCl₄ can generate mixed oxides. Incorporation of metal chlorides, nitrates, etc. of transition metals or rare earth metals can provide dopant metals to form luminescent centers. FSP of mixed metal oxide nanopowders has been discussed in G. D. Ulrich, Flame Synthesis of Fine Particulates,” CHEM. & ENG. NEWS, 8-6-84, 22-9; S. Vemury et al., “Electrically Controlled Flame Synthesis of Nanophase TiO₂, SiO₂ and SnO₂,” J. MATER. RES. 12, 1031-41 (1997); G. P. Fotou et al., COMBUSTION AND FLAME, 101, 529-38 (1995); S-L. Chung et al., J. AM. CERAM. SOC. 75, 117-23 (1992); M. Sokolowski et al., J. AEROSOL SCI., 8, 219-30 (1977); C.-H. Hung et al., J. MATER. RES. 7, 1861-70 (1992); C-H. Hung et al., J. MATER. RES. 8, 2404-13 (1993); A. J. Rulison et al., J. MATER. RES. 12, 3083-89 (1996); A. Gurav et al., AEROSOL SCI. TECH. 19, 411-52 (1993); and K. A. Klusters et al., POWDER TECH. 82, 79-91 (1995). In particular, mixed metal oxides of Ti, Al, Si, and Ge, with vanadium chlorides or oxychlorides have been investigated.

Katz et al. have disclosed production of nanopowders in counterflow H₂/O₂ diffusion flames, wherein mixed-metal chlorides (AlC₃ and SiCl₄) hydrolyze, generating mixtures of single metal oxide particles, or mixed metal oxide particles with one oxide coating the other. S-L. Chung et al., J. AM. CERAM. SOC. 75, 117-23 (1992) obtained similar results for counterflow diffusion flame synthesis of mullite powders from AlCl₃ and SiCl₄. The morphology and crystal structure is dependent upon the temperature, with amorphous particles being formed at low temperatures.

Pratsinis et al. discloses synthesis of nanoparticle TiO₂ employing laminar diffusion (H₂/O₂) FSP, including Al, Si, and Sn as “dopants.” Both solid solutions as well as core/shell morphologies are disclosed. Nanoparticle synthesis from metal alkyls employing flat flame, combustion-flame-chemical vapor condensation (CF-CVC) has been practiced by Nanopowder Enterprises, Piscataway, N.J.

However, the preferred method of synthesis of up- and down-converting metal oxide and mixed metal oxide luminescent center-containing nanoparticles is liquid feed flame spray pyrolysis (LF-FSP), which can operate with the exclusion of metal chlorides and metal alkyls, except optionally as dopants, and can employ relatively low cost, alcohol soluble precursors which are able to be synthesized from metal oxides, for example as disclosed in U.S. Pat. Nos. 5,418,298 and 5,614,596, both incorporated herein by reference. Methods of production of up- and down-converting metal oxide nanoparticles are disclosed in U.S. Pat. No. 5,958,361 and U.S. application Ser. No. 09/857,151, published as WO 00/038,282, herein incorporated by reference, and PCT published application WO 03/070640 A1, also incorporated herein by reference.

Further references which disclose suitable nanoparticles and methods for their preparation include C. R. Bickinore et al., EUROP. CERAM. SOC. 18, 287-97 (1998); R. M. Laine et al., “Ultrafine Powders by Flame Spray Pyrolysis,”; A. C. Sutorik et al., “Synthesis of Ultrafine □”-Alumina Powders via Flame Spray Pyrolysis of Polymeric Precursors,” J. AM. CERAM. SOC. 81, 1477-86 (1998); C. R. Bickmore et al., “Ultrafine Spinel Powders by Flame Spray Pyrolysis of a Magnesium Aluminum Double Alkoxide,” J. AM. CERAM. SOC. 79, 1419-23 (1996); R. M. Laine et al., J. CHEM. MATER. 6, 1441-3 (1996); K. Waldner et al., CHEM. MATER. 8, 2850-7 (1996); A. C. Sutorik et al., J. AM. CERAM. SOC. 81, 1477-86 (1998); C. Bickmore et al., J. AM. CERAM. SOC. 79, 1419-23 (1996); T. Hinklin et al., “Liquid-Feed Spray Pyrolytic Synthesis of Nanoalumina Powders,” CHEM. MATER., In press; Julien Marchal et al., “Yttrium Aluminum Garnet Nanopowders by Flame Spray Pyrolysis,” CHEM. MATER., In press; S. Li et al., “Synthesis and Characterizatio of Y₂O₂S: Yb³⁺, Er³⁺, Up-Conveting [sic] Nanophosphors,” in NANOSCIENCE AND NANO-TECHNOLOGY IN PERSPECTIVE, Tsignhua Press, June, 2002, pp. 221-33; T. Hinklin et al, unpublished data; and R. M. Laine et al., “Novel Synthetic and Processing Routes to Ceramics,” Uematsu, H. Otsuka, Eds., KEY ENGINEERING MATERIALS Vols. 159-160, Trans Tech Publ. Ltd. Switzerland, 1998, pp. 17-24.

For those less familiar with up- and down-conversion, these physicooptical properties both involve emission of radiation at a wavelength or at multiple wavelengths which is/are different from the wavelength of irradiative energy to which the substance, here doped, metal or mixed metal oxide nanoparticles, are exposed. In up-conversion, energy absorbed by the substrate is “pooled” and re-emitted as higher energy light of a correspondingly shorter wavelength. In down-conversion, energy is absorbed and re-emitted as light of lesser energy, for example as multiple emissions of longer wavelength. Up- and down-conversion are well known properties.

For example, in up-converting nanoparticles, the irradiating light may be in the infrared region of the spectrum, while the re-emitted light may be in the visible range. By suitable choice of metal dopants, dopant concentration, and metal oxide lattice, visible emission ranging from red to blue light may be obtained. In down-converting nanoparticles, UV light, x-ray, electron beams, or even visible light may be applied, and re-emitted in a longer wavelength portion of the electromagnetic spectrum.

Sources of irrading light are preferably tailored to the absorption frequencies of the luminescent centers of the nanoparticles. Thus, while broadband radiation, or filtered light designed to produce a somewhat narrower range of wavelengths may be used, it is preferable to employ a laser source or other source of one or more substantially monotonic wavelength emission modes. When using such sources, light reemitted may be optically isolated from the irrading light due to differences in the respective wavelengths. When broadband or “narrowband” irradiation is employed, isolation of the re-emitted light from the irradiating light source is more difficult.

For example, with up-converting nanoparticles which absorb infrared light and emit light in the visible region, using a heat lamp, which emits significant visible light, will not provide the isolation, or “signal to noise ratio” which can be obtained by use of an infrared emitting laser as the irradiating source. Further improvement in detection capability may be obtained by modulating the irradiating light, which is easily done with lasers, particularly semiconductor lasers and photodiodes, and synchronously detecting the emitted light.

Detection is enhanced when multiple emissions are produced, i.e. at different wavelengths. These multiple emissions may be from multiple and different luminescent centers within single nanoparticles, for example heterophase particles with different dopants or dopant levels in each phase, or through the use of two or more types of particles, each having at least one, and preferably more than one emission. By suitable combinations, many different taggant compositions can be created which can be distinguished from each other.

These taggants have numerous and varied uses. For example, they may be previously incorporated into ceramic, metal, and polymer prosthetic devices, allowing for identification of their manufacturer, and even the particular batch of prostheses or the batch of materials employed in their manufacture. The nanoparticles may be present in inks, coatings, watermarks, or the paper or polymer substrates of legal documents, including paper currency, and may be incorporated in metal coinage as well. The taggants may be incorporated in batches of alloys, explosives, and polymers of many kinds. In addition to detecting the source or genuineness of taggant-containing articles or substances, the taggants may also be used for applications such as inventory control, or in “friend or foe” recognition, by incorporating the taggants into the metal or polymer structure of tanks, fighter aircraft, personnel vehicles, or the like, or as a paint coating on such equipment. Interrogation by a laser beam source and detection of the reflected emitted light can determine the identity of the equipment.

The doped up- and down-converting nanopowders may be used as produced, or may be chemically modified prior to use, for example, by sulfiding or fluoriding. The particles may also be treated to increase their compatibility with the matrix. For example, for addition to some polymers, it may be desirable to hydrophobicize the particles by treatment with hydrophobicizing agents such as waxes, long chain fatty acids or their salts, organopolysiloxanes, reactive silanes and/or silazanes, etc.

The metal oxide of the matrix may be selected with regard to the temperatures expected during incorporation and use. Thus, for example, in inks, paints, polymer systems, etc., the metal oxide or oxides of the nanoparticle matrix may have but a modest melting point, while for higher temperatures such as addition to molten metals, to ceramics, or to explosives or explosive components, i.e. ammonium nitrate, a higher melting metal oxide will in general be necessary. Single metal oxide systems include but are not limited to metal oxides of Zn, Mg, Al, Si, Ti, Y, and U, while mixed metal oxide systems include but are not limited to Y₃ Al₅ O₁₂, Mg Al₂ O₄, and Ta₂ Zn₃ O₈, in addition to the metal oxides and mixed metal oxides described previously.

The transition metal and rare earth metals which may be added as dopants include any which can form luminescent centers in the metal oxide or mixed metal oxide matrix in which they are incorporated. Non-limiting examples include Yb, Eu, Er, Tm, Gd, U, Tb, Pr, Ce, V, Mo, Mn, Zn, Al, Ru, Fe, Co, and Cr. Note that Al and other non-transition elements may also serve as dopants in matrices which are not oxides of the same element. Doping with two or more elements is not only possible, but preferable in many cases. The dopants may be added in an concentration which allows for up- and/or down-conversion. It is noted that in some preparation methods, such as LF-FSP, dopant atoms may be present in greater than their equilibrium concentration.

The doped metal oxides may also include other oxides such as those of B, P, As, and the like. The ability to up- and/or down-convert, and the intensity of the emitted light can be evaluated by standard methods now well known to those skilled in the art.

The particle size of the nanoparticles may range downwards from 500 nm, and are preferably smaller (average particle size) than 300 nm, more preferably smaller than 200 nm, and most preferably smaller than 100 nm. In transparent articles, very small particles in the range of 0.1 nm to 50 nm, preferably 1 nm to 20 nm can produce transparent articles due to their very small size.

The amount of nanoparticles to be incorporated is dependent on several factors, but in any case must be of a quantity which produces an emissive output which is distinguishable for the background by at least one method of detection. Thus, the minimum amount is dependent upon the detection method desired as well as upon the nature of the matrix to which it is to be added. Matrices (“substrates”) which mask emissions will ordinarily require a higher level of taggant, for example. The amount thus may range, for example, from about 0.001 weight percent or lower, to 10 weight percent or higher, preferably 0.001 weight percent to 1 weight percent, and more preferably 0.01 weight percent to 1 weight percent. The requisite amount can be simply measured by preparing a sample, illuminating with test light of the desired wavelength or wavelengths, and measuring emission as compared to a blank sample containing no taggant. These tests are routine, and do not require undue experimentation.

In metal compositions, the taggants may be added to metal powders, optionally with binders, which are then sintered under pressure and/or heat to a sintered metal article, or may be added to molten metal as particles per se or as a master alloy containing the taggants. In ceramic materials such as BN, SiC, SiNC, SiO₂, A1₂O₃, etc., the taggants may be added to a slip or moulding material which is later fired, or to ceramic particles and/or precursors thereof which are then sintered, generally under heat and pressure. In polymer systems, the taggants may be added to thermoplastic polymers in the melt, in an extruder (generally employing a master batch, or during polymer synthesis). In the case of two- or multi-component thermoset polymers, the taggants may be added to one or more of the reactive ingredients. For example, taggants may be incorporated in the resin B-side in polyurethane RIM molding which is often used for vehicle bumpers, fascias, etc. Counterfeit parts can easily be detected as a result.

Having generally described this invention, a further understanding can be obtained by reference to certain specific examples which are provided herein for purposes of illustration only and are not intended to be limiting unless otherwise specified.

### EXAMPLE 1

4.00 g of “Ecka aluminum” particles ranging in size from 250-500 nm and having a purity of ≧99.3%, available from Eckart Aluminum, Australia, was milled in a high-energy planetary rotation ball mill (SPEX CertiPrep 020 mixer/mill) with 4.00 g of an up-converting taggant of alumina/yttria of composition MₓYb_{y}Y_{2-x-y}O₃, where M is Er, x is from 0.66-0.8 and y is from 0.04-0.02, available from TAL Materials, Ann Arbor, Mich., and having an average particle size of less than 100 nm. The mixing chamber was a stainless steel cylinder with internal volume of 85 cm³, and 32 g of stainless steel milling media of various sizes were added. The cylinder was flushed with Ar and sealed. The Ar flush ensures that no oxidation takes place during milling. The mill was run for 2.5 hours, and the resulting relatively homogenous powder was separated from the milling media. This process is repeated five times to produce 40.00 g of aluminum/taggant master batch.

From the master batch, a “master alloy bar” was prepared by introducing the master batch into a 2.86×8.89 cm rectangular die and pressed in a Carver Press to a holding pressure of 41.5 MPa for 2 minutes, followed by slow pressure release. The density of the bar was between 1.85 and 1.90 g/cm³, indicating about 48-49% of theoretical density.

A master alloy bar as prepared above is added to a 35 lb (15.6 Kg) melt of substantially pure aluminum and distributed uniformly within. The concentration of nanoparticles is thus 0.125 weight percent, or 1.44·10⁻⁵ mol %.

### EXAMPLE 2

The powder of Example 1 is followed, except that the nanoparticles are doped with Tm instead of Er.

### EXAMPLE 3

While still molten, one half of the taggant-laden aluminum of Example 1 was mixed with one half the taggant-laden aluminum of Example 2 to form aluminum containing both taggants.

### EXAMPLES 4-6

From each of the taggant-laden aluminum melts of Examples 1-3, 11b (454 g) ingots were cast, and test specimens measuring 2.54 cm×2.54 cm×0.7 cm were cut with a band saw. Test filings were taken from each sample, and surfaces were published on a series of polishing wheels, the last employing 0.3 μm polishing media. The polished surfaces were etched with 1% nitric acid in methanol (NITANOL™), and SEM images were taken. The SEM images showed only embedded polishing particles, even at high magnification (5000-10,000_{X}).

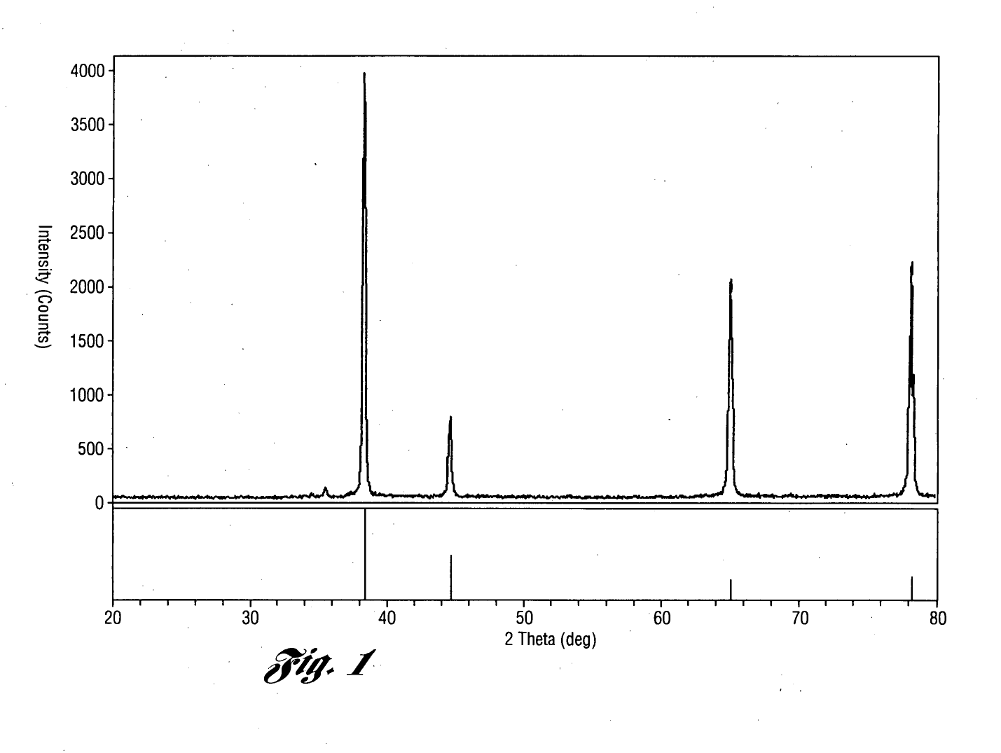

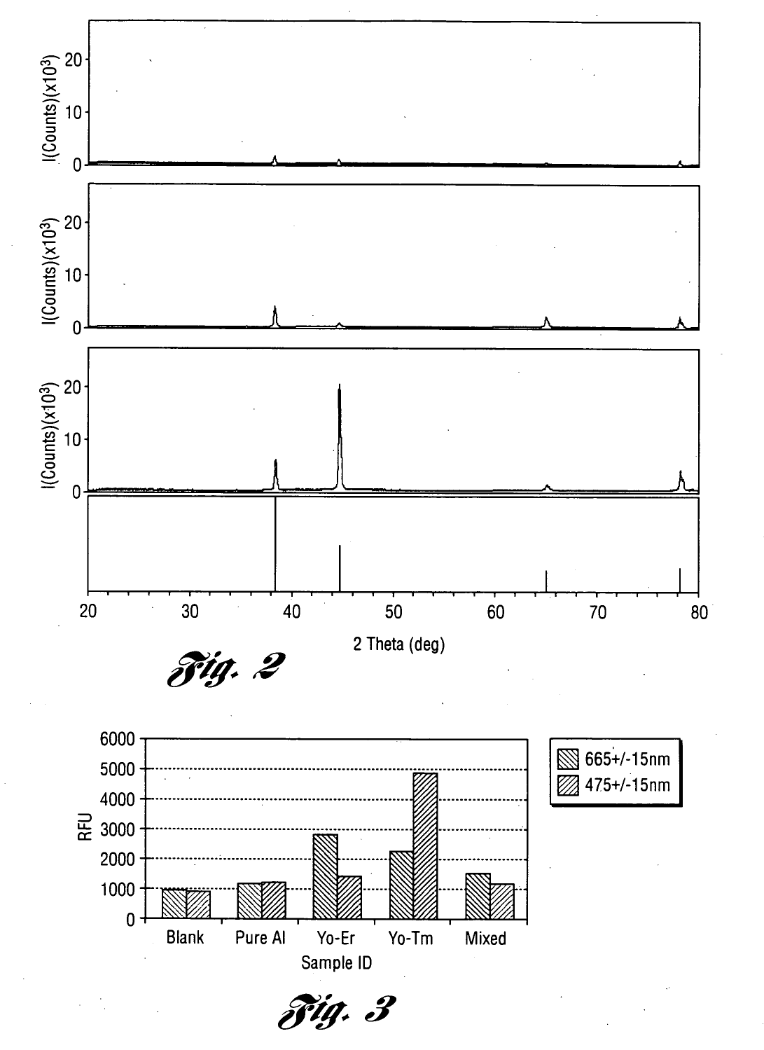

X-ray diffraction (XRD) patterns of the specimens were taken to determine the purity and species present in the samples. The scan range was from 20° to 80° 2θ, at 2°/min using Cu K_{α} radiation. The scan showed that the sample consisted substantially of pure aluminum, with particles of Tm, Er, or both Tm and Er doped yttria particles, indicating that the particles survived the blending and casting operations. The XRD spectrum of aluminum is shown in FIG. 1, while the XRD spectra of each of the samples of Examples 4, 5, and 6 are shown as a composite in FIG. 2.

Samples are also tested for emission with a modified Hewlett Packard Fluorocount Reader equipped with an Opto Power IR laser. The fine filings are loaded in round bottom microtiter, and fluorescent signals are collected by scanning a 21×21 pixel area of each sample. Since the scanned areas are 50% greater than each sample well, 100% of the fluorescent signals are captured. Laser power level was set at 1500 mA, corresponding to about 1.0W output. Detection was made at two selected frequencies, 475 and 665 nm, corresponding to emission from Yb—Tm and Yb—Er, respectively. The samples were also compared to a blank (no sample, and Ecka aluminum). The results are shown in FIG. 3. Note that both the blank and the aluminum gave non-zero values. The pure aluminum had a background of about 1000 counts, for example. In comparing the taggant-containing compositions, it should be noted that the composition of Example 3 (“mixed”) contains both taggants, but at only 0.5 of the concentration of the samples of Example 1 (“Yb—Er”) and Example 2 (“Yb—Tm”). It can be seen that in this detection system, each individual taggant-laden article can be clearly identified, with both red and blue emissions well above the background. In the sample of Example 6, the presence of taggant is observable at 665 m, but is at about the background level at 475 nm. Thus, in this system, it would be advisable to have the concentration of taggant above about 0.0625% by weight. However, use of a higher powered laser or one of different frequency, as well as detection at different frequencies can lower the detectable concentration. For example, 475 nm is not a particularly good wavelength to detect shorter wavelength emissions of Er doped yttria, as can be seen from the emission spectrum of FIG. 4. Significant emission occurs over the range of ca. 530-560 nm, for example.

### EXAMPLE 7

Pyrex glass is ground and mixed with Er-doped yttria as previously used, at 10 weight percent and 25 weight percent. The mixtures were thoroughly mixed by mechanical milling, and 0.5 g samples pressed at 100 MPa to form pellets, which were subsequently heated to 1000° C. at 5° C./min and then furnace cooled. The resulting opaque glass materials gave red responses to 980 nm light commensurate with that of the original nanoparticles, demonstrating that no substantial reaction took place between the yttri and the pyrex matrix, which might have been expected.

### EXAMPLE 8

Polystyrene powder is thoroughly mixed with Er,Yb-doped yttria powder at 1 weight percent and 10 weight percent and heated in a mold to melt the polystyrene, with gentle stirring. The molten mixture is cooled to produce polystyrene laden with nanoparticle taggants. The opaque polymaterials emit red light in response to 980 nm infrared irradiation.

### EXAMPLE 9

An up-converting nanopowder of composition Y_{0.86} Yb_{0.11} Er_{0.03} O₃ from TAL Materials is admixed with an epoxy resin (Epofix™, Struers, Rodoure, Denmark; 8:1 resin to hardener ratio) at concentrations of 1%, 2%, 5%, 10%, and 20%. A composition contains no taggant. The epoxy resin is allowed to cure overnight. Cylindrical samples measuring 2.5 cm diameter and 0.3 cm thickness were then demolded. The control sample was transparent, while the taggant-laden samples ranged from translucent to opaque white. When exposed to 980 nm IR light, even the 1% sample exhibited up-conversion visible to the eye, giving observable red light. While a down-converting emission is also possible, this mode (using UV illumination) is obscured by luminescence of the epoxy matrix. It is clear that when employing more sophisticated detection methods, a much lower concentration of taggant would suffice.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A process for rendering a manufactured article identifiable, comprising adding to said article during its manufacture or coating upon said article, a quantity of at least one taggant selected from the group consisting of up-converting, down-converting, and up- and down-converting metal oxide nanoparticles having an average size of less than 500 nm, said quantity sufficient upon illumination by an exciting energy source to generate an emission detectable against a background, said emission having a wavelength different from the wavelength absorbed by the taggant.

2. The process of claim 1, wherein said metal oxide nanoparticles are mixed metal oxide nanoparticles.

3. The process of claim 1, wherein said nanoparticles have an average size of less than 200 nm.

4. The process of claim 1, wherein said nanoparticles have an average size of less than 100 nm.

5. The process of claim 2, wherein said mixed metal oxide nanoparticles comprise a plurality of phases of metal oxide of differing composition.

6. The process of claim 1, wherein said nanoparticles contain luminescent centers comprising at least one transition metal or rare earth metal dopant in a metal oxide matrix.

7. The process of claim 2, wherein said nanoparticles contain luminescent centers comprising at least one transition metal or rare earth metal dopant in a metal oxide matrix.

8. The process of claim 6, wherein at least one of said dopants is one selected from the group consisting of Yb, Eu, Er, Tm, Gd, U, Pr, Ce, Mn, Zn, Ru, Fe, Co, and Cr.

9. The process of claim 1, wherein at least a portion of said nanoparticles comprise yttria doped with one or more transition or rare earth dopant metals.

10. The process of claim 1, wherein at least two different populations of nanoparticles are employed, each population containing nanoparticles exhibiting a different emission than at least one other population of nanoparticles.

11. An article prepared by the process of claim 1.

12. An article prepared by the process of claim 2.

13. An article prepared by the process of claim 4.

14. An article prepared by the process of claim 6.

15. An article prepared by the process of claim 10.

16. The article of claim 10 which is a metal or metal alloy.

17. The article of claim 10 which comprises a glass or ceramic material.

18. The article of claim 10 which comprises a polymer.

19. A process for identifying a taggant-laden article, comprising
exposing an article prepared by the process of claim 1 with an energy source absorbable by said nanoparticles and causing said nanoparticles to emit light energy as a result of said exposing;
detecting one or more wavelengths of emission of said nanoparticles, and comparing detected emission to emission expected of an article containing said nanoparticles.

20. The process of claim 19, wherein said nanoparticles have an average particle size of less than 100 nm, and comprise at least one metal oxide containing transition or rare earth metal doped luminescent centers.

21. The process of claim 20, wherein said nanoparticles are multiphase nanoparticles containing at least two phases of metal oxides of different compositions.

22. The process of claim 19, wherein said nanoparticles comprise at least two different populations of nanoparticles are employed, each population containing nanoparticles exhibiting a different emission than at least one other population of nanoparticles.

23. The process of claim 19, wherein said energy source comprises infrared light, ultraviolet light, or both infrared and ultraviolet light, and said nanoparticles emit visible light.

24. The process of claim 23, wherein said energy source comprises one or more lasers.
